(19) United States
(12) Patent Application Publication
(10) Pub. No.: US 2011/0264279 A1
(43) Pub. Date: Oct. 27, 2011

(54) HVAC control

(76) Inventor: Robert J. Poth, Austin, TX (US)

(21) Appl. No.: 13/066,784

(22) Filed: Apr. 25, 2011

Related U.S. Application Data
(60) Provisional application No. 61/343,139, filed on Apr. 23, 2010.

(51) Int. Cl. G05B 13/00; G06F 15/00

(52) U.S. Cl. 700/278; 702/130

(57) ABSTRACT

A method of monitoring HVAC usage includes: maintaining a data structure in an on board memory of a programmable usage monitoring HVAC thermostat; receiving an initiation signal from a relay; receiving a termination signal from the relay; and updating the data structure by adding a duration in units of time to an accumulated time associated with the relay to keep a log of the elapsed time a function associated with the relay was operative. A programmable usage monitoring HVAC thermostat comprising, a user interface; a microprocessor coupled to the user interface; and a firmware upgradeable memory coupled to the microprocessor.

### CROSS-REFERENCE TO RELATED APPLICATION

This application claims a benefit of priority under 35 U.S.C. 119(e) from copending provisional patent application U.S. Ser. No. 61/343,139, filed Apr. 23, 2010, the entire contents of which are hereby expressly incorporated herein by reference for all purposes.

### BACKGROUND INFORMATION

1. Field of the Invention

Embodiments of the invention relate generally to the field of heating, ventilation and air conditioning (HVAC) control. More particularly, embodiments of the invention include HVAC systems, usage monitoring programmable HVAC thermostats and/or related methodologies.

2. Discussion of the Related Art

Prior art programmable thermostats are known to those skilled in the art. For instance, a conventional programmable thermostat is typically capable of storing different set points for different time periods of the day and/or week.

A problem with this technology has been inadequate monitoring of system component usage. Therefore, what is required is solution that provides better monitoring of the usage of components of the system.

Another problem with this technology has been that service of the system can require that system functions be manually actuated to verify that they are functioning correctly. Therefore, what is also required is a solution that provides the option to activate different system functions.

Another problem with this technology has been the inability to upgrade on-board components of the programmable thermostat. Therefore, what is also required is a solution the provides the ability to upgrade on-board components of the programmable thermostat.

Another problem with this technology has been the inability of HVAC systems to respond appropriately to a non-normal physical situation. Therefore, what is also required is a solution that enables an HVAC system to respond appropriately to an unusual physical situation.

Another problem with this technology has been the inability of HVAC systems to respond appropriately to a constant call situation where the system is running constantly. Therefore, what is also required is a solution that enables an HVAC system to respond appropriately to a constant call situation.

Another problem with this technology has been a lack of information regarding temperature within components of the HVAC system, as opposed to the temperature within the thermostat or the temperature of a remote sensor. Therefore, what is also needed is a solution that provides data relating to the temperature within components of the system.

Another problem with this technology has been inability of HVAC systems to respond appropriately to a non-normal functioning of the system itself. Therefore, what is also required is a solution that enables an HVAC system to respond appropriately to a malfunction situation.

### SUMMARY OF THE INVENTION

There is a need for the following embodiments of the invention. Of course, the invention is not limited to these embodiments.

According to an embodiment of the invention, a method of monitoring HVAC usage, comprises: maintaining a data structure in an on board memory of a programmable usage monitoring HVAC thermostat; receiving an initiation signal from a relay; receiving a termination signal from the relay; and updating the data structure by adding a duration in units of time to an accumulated time associated with the relay to keep a log of the elapsed time a function associated with the relay was operative. According to another embodiment of the invention, a method of servicing an HVAC system, comprises: setting a programmable usage monitoring HVAC thermostat into a service state; and setting a mode of the programmable usage monitoring HVAC thermostat to run in a cooling stage 1, a cooling stage 2, a heating stage 1 or a heating stage 2 to verify that the mode is operating properly. According to another embodiment of the invention, a programmable usage monitoring HVAC thermostat comprises: a user interface; a microprocessor coupled to the user interface; and a firmware upgradeable memory coupled to the microprocessor. According to another embodiment of the invention, a method of operating an HVAC system, comprises: enabling an open interlock function of a programmable usage monitoring HVAC thermostat; detecting that an interlock is open; measuring a period of time during which the interlock remains open; and when the period of time exceeds a preset threshold, displaying an open notice. According to another embodiment of the invention, a method of operating an HVAC system, comprising: enabling an overload function of a programmable usage monitoring HVAC thermostat; measuring a period of time during which the programmable usage monitoring HVAC thermostat is calling for cooling or heating; and when the period of time exceeds a preset threshold, displaying an overload notice. According to another embodiment of the invention, a system, comprises: a programmable usage monitoring HVAC thermostat including a user interface, a microprocessor coupled to the user interface and a memory coupled to the microprocessor; and a temperature sensor coupled to the programmable usage monitoring HVAC thermostat, the temperature sensor located in an HVAC duct. According to another embodiment of the invention, a method of operating an HVAC system, comprising: monitoring periodically a plurality of relays coupled to a programmable usage monitoring HVAC thermostat; and when one or more of the plurality of relays is found to be in a non-conforming state, displaying a malfunction notice.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 is a flow diagram of a relay logging process that can be implemented by a computer program, representing an embodiment of the invention.

FIG. 2 is a flow diagram of a service mode process that can be implemented by a computer program, representing an embodiment of the invention.

FIG. 3 is a schematic diagram of a system, representing an embodiment of the invention.

FIG. 4 is a flow diagram of an overload open process that can be implemented by a computer program, representing an embodiment of the invention.

FIG. 5 is a flow diagram of an interlock process that can be implemented by a computer program, representing an embodiment of the invention.

FIG. 6 is a flow diagram of a relay compliance process that can be implemented by a computer program, representing an embodiment of the invention.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The below-referenced U.S. Patent(s) and U.S. Patent Application(s) disclose embodiments that are useful for the purposes for which they are intended. The entire contents of U.S. Pat. No(s). 6,741,915; 7,003,378; 7,216,015; 7,555,364; and 7,707,428 are hereby expressly incorporated by reference herein for all purposes. The entire contents of U.S. Serial No(s). 11/982,001 filed Oct. 29, 2007 (20080183335) and 11/981,867 filed Oct. 29, 2007 (20080065926) are hereby expressly incorporated by reference herein for all purposes.

The context of the invention can include commercial buildings where a plurality of users require HVAC system services. Such a plurality of users may have different needs and schedules and it is an advantage of the invention to enable these users to activate service to meet their own needs while simultaneously protecting the interests of other users, as well as the building management/owners. The context of the invention can also include residential buildings.

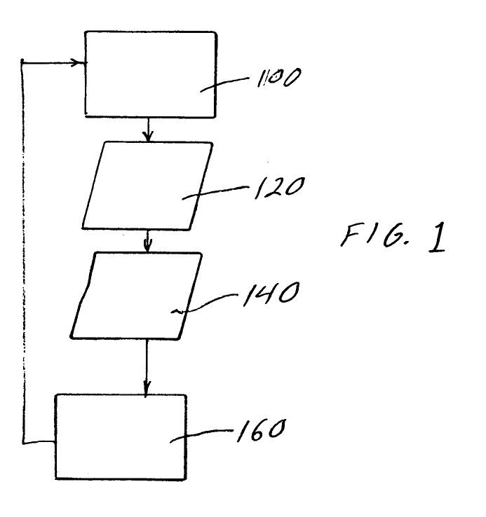

An embodiment of the invention can also include a programmable HVAC thermostat with a system use function which measures the time a relay is initiated so that that relayed function is measured in hourly use to indicate when service of a component is indicated by hourly use logging based on when one (or more) relay(s) open(s) and close(s). This can keep a log of the time a function of the system is called for, cooling, heating, 1 and multiple stages, ect. Referring to FIG. 1, a method of monitoring HVAC usage can include maintaining 100 a data structure in an on board memory of a programmable usage monitoring HVAC thermostat; receiving 120 an initiation signal from a relay; receiving 140 a termination signal from the relay; and updating 160 the data structure by adding a duration in units of time to an accumulated time associated with the relay to keep a log of the elapsed time a function associated with the relay has been operative. Optionally, the accumulated time can be recorded each cycle, each day and/or each week, or more.

An embodiment of the invention can include a programmable HVAC thermostat with a service function which allows the service technician to set the mode of the HVAC system to run in cooling stage 1, cooling sage 2, heating stage 1, heating stage 2 and other functions as requested to allow the technician to verify those functions are operating properly. Referring to FIG. 2, setting 220 a programmable usage monitoring HVAC thermostat into a service state is followed by setting 240 a mode of the programmable usage monitoring HVAC thermostat to run in a cooling stage 1, a cooling stage 2, a heating stage 1 or a heating stage 2 to verify that the mode is operating properly This allows the service technician to place the HVAC system into a set function of cooling, heating, 1 and multiple stages, etc. to check out the operation of that function and verify all components are operating properly. Optionally, this can include repeating setting 260 the mode automatically to “poll” (sequentially) verify the system functions.

Referring to FIG. 3, an embodiment of the invention can also include a programmable HVAC thermostat with a firmware upgrade(able) memory 330 (e.g., EPROM). A programmable usage monitoring HVAC thermostat 300 includes a user interface 310, a microprocessor 320 coupled to the user interface; and a firmware upgradeable memory 300 coupled to the microprocessor 320. In this embodiment, optionally the firmware upgradeable memory includes two sectors 331, 332, wherein 1) a first sector is mirrored by a second sector during operation in a first mode, 2) the first sector can be upgraded while the second sector is not upgraded during operation in a second mode, 3) the first sector can be operationally connected to the microprocessor in a third mode and 4) the second sector can be operationally connected to the microprocessor in a fourth mode, and wherein the firmware upgradeable memory can be reversibly switched from a first member selected from the group consisting of the first mode, the second mode, the third mode and the fourth mode to a second member selected from the group consisting of the first mode, the second mode, the third mode and the fourth mode, thereby providing a firmware upgradeable memory with hot swappable sectors and a firmware reversion capability.

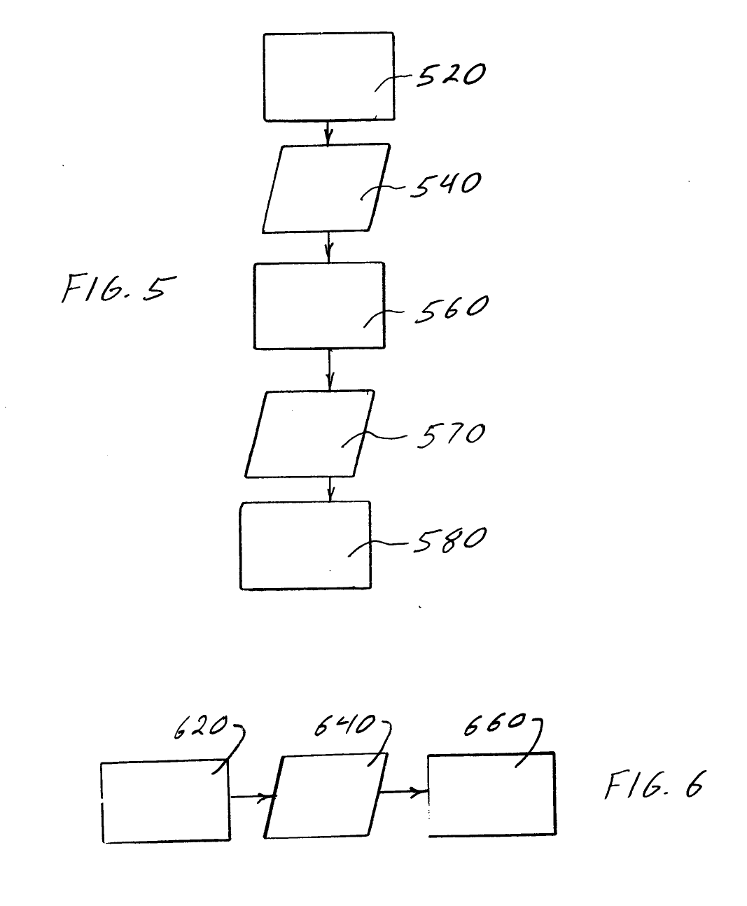

An embodiment of the invention can also include a programmable HVAC thermostat with a function that detects an open interlock 340. Referring to FIG. 5, enabling 520 an open interlock function of a programmable usage monitoring HVAC thermostat; detecting 540 that an interlock is open; measuring 560 a period of time during which the interlock remains open; and when the period of time exceeds a preset threshold, displaying 570 an open notice and/or forcing 580 an OFF state. For instance, after a door is left open for a predetermined time, the system is forced OFF until the door is closed.

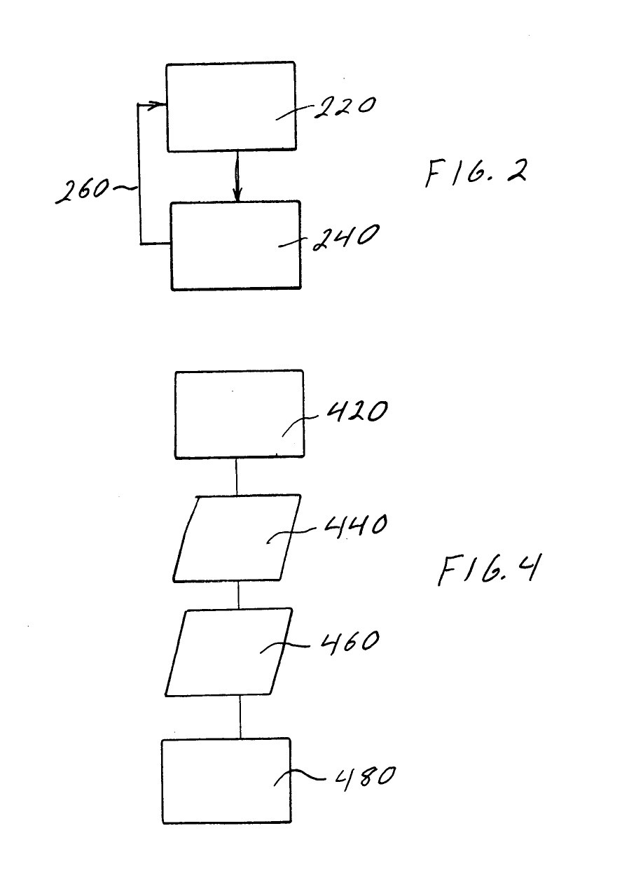

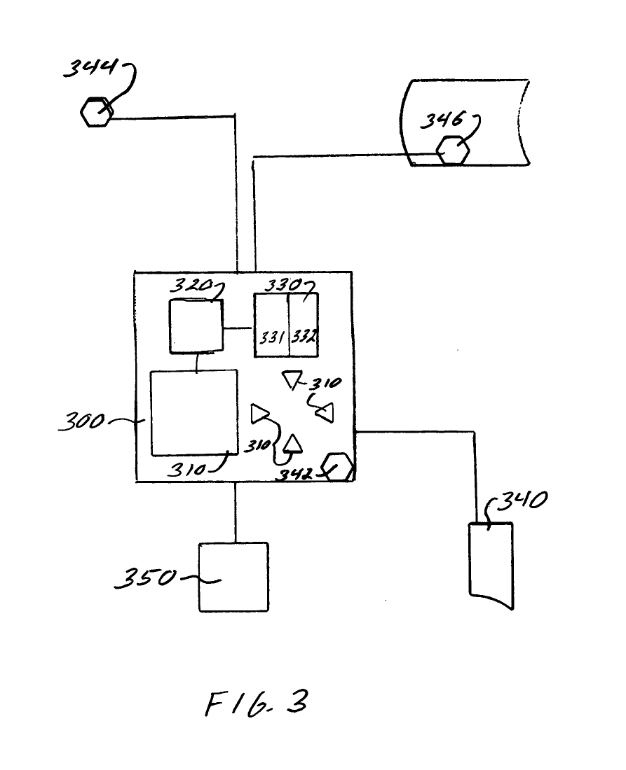

An embodiment of the invention can also include a programmable HVAC thermostat with a function to switch the operating Mode to Off and display a notice which reads “Malfunction—Call Service” if the system is calling for cooling or heating and the set point is not achieved within a predefined period of time. Referring to FIG. 4, enabling 420 an overload function of a programmable usage monitoring HVAC thermostat is followed by measuring 440 a period of time during which the programmable usage monitoring HVAC thermostat is calling for cooling or heating; and when the period of time exceeds a preset threshold, displaying 460 an overload notice and/or when the period of time exceeds the preset threshold forcing 480 the HVAC system to an OFF state.

An embodiment of the invention can include multiple temperatures sensors. These multiple sensors can include, but are not limited to, an internal sensor 342, a remote sensor 344 and a duct sensor 346. In a preferred embodiment, the duct sensor can be read once every four seconds to a resolution of 0.125° C. and displayed to 1° C. or 1° F. resolution. In a preferred embodiment, the reading of this sensor is displayed only in a “service” screen.

An embodiment of the invention can also include an HVAC system whose operating includes monitoring periodically a plurality of relays 350 coupled to a programmable usage monitoring HVAC thermostat 300; and when one or more of the plurality of relays is found to be in a non-conforming state, displaying a malfunction notice and/or forcing the HVAC system to an OFF state. Referring to FIG. 6, monitoring periodically 620 a plurality of relays coupled to a programmable usage monitoring HVAC thermostat and then when one or more of the plurality of relays is found to be in a non-conforming state, displaying 640 a malfunction notice and/or forcing 660 the HVAC system to an OFF state.

An embodiment of the invention can also be included in a kit-of-parts. The kit-of-parts can include some, or all, of the components that an embodiment of the invention includes. The kit-of-parts can be an in-the-field retrofit kit-of-parts to improve existing systems that are capable of incorporating an embodiment of the invention. The kit-of-parts can include software, firmware and/or hardware for carrying out an embodiment of the invention. The kit-of-parts can also contain instructions for practicing an embodiment of the invention. Unless otherwise specified, the components, software, firmware, hardware and/or instructions of the kit-of-parts can be the same as those used in an embodiment of the invention.

### DEFINITIONS

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another. and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences.

Various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method of monitoring HVAC usage, comprising:
maintaining a data structure in an on board memory of a programmable usage monitoring HVAC thermostat;
receiving an initiation signal from a relay;
receiving a termination signal from the relay; and
updating the data structure by adding a duration in units of time to an accumulated time associated with the relay to keep a log of the elapsed time a function associated with the relay was operative.

2. The method of monitoring HVAC usage of claim 1, wherein the accumulated time associated with the relay is recorded each initiation-termination cycle.

3. The method monitoring HVAC usage of claim 1, wherein the accumulated time associated with the relay is recorded each day.

4. The method of monitoring HVAC usage of claim 1, wherein the accumulated time associated with the relay is recorded each week.

5. A machine readable medium, comprising a program for performing the method of claim 1.

6. A method of servicing an HVAC system, comprising:
setting a programmable usage monitoring HVAC thermostat into a service state; and
setting a mode of the programmable usage monitoring HVAC thermostat to run in a cooling stage 1, a cooling stage 2, a heating stage 1 or a heating stage 2 to verify that the mode is operating properly

7. The method of servicing an HVAC system of claim 6, further comprising repeating setting the mode automatically.

8. The method of servicing an HVAC system of claim 7, further comprising repeating setting the mode automatically until all available modes are polled as verified.

9. A programmable usage monitoring HVAC thermostat, comprising:
a user interface;
a microprocessor coupled to the user interface; and
a firmware upgradeable memory coupled to the microprocessor.

10. The programmable usage monitoring HVAC thermostat of claim 9, wherein the firmware upgradeable memory includes an erasable programmable read only memory.

11. The programmable usage monitoring HVAC thermostat of claim 9, wherein the firmware upgradeable memory includes two sectors, wherein 1) a first sector is mirrored by a second sector during operation in a first mode, 2) the first sector can be upgraded while the second sector is not upgraded during operation in a second mode, 3) the first sector can be operationally connected to the microprocessor in a third mode and 4) the second sector can be operationally connected to the microprocessor in a fourth mode, and wherein the firmware upgradeable memory can be reversibly switched from a first member selected from the group consisting of the first mode, the second mode, the third mode and the fourth mode to a second member selected from the group consisting of the first mode, the second mode, the third mode and the fourth mode, thereby providing a firmware upgradeable memory with hot swappable sectors and a firmware reversion capability.

12. A method of operating an HVAC system, comprising:
enabling an open interlock function of a programmable usage monitoring HVAC thermostat;
detecting that an interlock is open;
measuring a period of time during which the interlock remains open; and
when the period of time exceeds a preset threshold, displaying an open notice.

13. The method of operating an HVAC system of claim 12, further comprising, when one or more of the period of time exceeds a preset threshold, forcing the HVAC system to an OFF state until the interlock is closed.

14. The method of operating an HVAC system of claim 12, wherein detecting includes sensing that a door is open.

15. A method of operating an HVAC system, comprising:
enabling an overload function of a programmable usage monitoring HVAC thermostat;
measuring a period of time during which the programmable usage monitoring HVAC thermostat is calling for cooling or heating; and
when the period of time exceeds a preset threshold, displaying an overload notice.

16. The method of operating an HVAC system of claim 15, further comprising, when the period of time exceeds the preset threshold, forcing the HVAC system to an OFF state.

17. A system, comprising:
a programmable usage monitoring HVAC thermostat including
a user interface,
a microprocessor coupled to the user interface and
a memory coupled to the microprocessor; and
a temperature sensor coupled to the programmable usage monitoring HVAC thermostat, the temperature sensor located in an HVAC duct.

18. The system of claim 17, further comprising i) an internal temperature sensor located in the programmable usage monitoring HVAC thermostat and a remote sensor not located in the HVAC duct.

19. A method of operating an HVAC system, comprising:
monitoring periodically a plurality of relays coupled to a programmable usage monitoring HVAC thermostat; and
when one or more of the plurality of relays is found to be in a non-conforming state, displaying a malfunction notice.

20. The method of operating an HVAC system of claim 19, further comprising, when one or more of the plurality of relays is found to be in a nonconforming state, forcing the HVAC system to an OFF state.
